(19) United States
(12) Patent Application Publication
(10) Pub. No.: US 2025/0039836 A1
(43) Pub. Date: Jan. 30, 2025

(54) INFORMATION PROCESSING METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Jingran CHEN, Dongguan (CN)

(21) Appl. No.: 18/915,165

(22) Filed: Oct. 14, 2024

Related U.S. Application Data
(63) Continuation of application No. PCT/CN2022/111276, filed on Aug. 9, 2022.

(51) Int. Cl. H04W 64/00

(52) U.S. Cl. CPC H04W 64/00

(57) ABSTRACT

This application relates to an information processing method, a terminal device, and a network device. The method includes: receiving, by a first network device, first information, where the first information is used to request positioning, and the first information is related to a first application that requests a location of a first terminal device; and transmitting, by the first network device, second information, where the second information is used to trigger the first terminal device to execute a discovery process, to determine a target second terminal device used for positioning.

### CROSS-REFERENCE TO RELATED APPLICATIONS

This application is a continuation of International Application No. PCT/CN2022/111276, filed on Aug. 9, 2022, the disclosure of which is hereby incorporated by reference in its entirety.

### TECHNICAL FIELD

This application relates to the field of communications, and more specifically, to an information processing method, a terminal device, and a network device.

### BACKGROUND

A terminal device that has a short-range communication capability may establish a connection to another terminal device that has a short-range communication capability by using a sidelink radio interface, to perform direct communication. Before two terminal devices perform short-range communication, a terminal device that has a short-range communication capability may also first perform a short-range discovery operation, to discover other terminal devices adjacent to the terminal device, thereby selecting a proper target terminal device to establish a direct communication connection. However, how to apply discovery processing between terminal devices to more scenarios becomes a problem that needs to be resolved.

### SUMMARY

Embodiments of this application provide an information processing method, a terminal device, and a network device.

An embodiment of this application provides an information processing method, including:
receiving, by a first network device, first information, where the first information is used to request positioning; and
transmitting, by the first network device, second information, where the second information is used to trigger the first terminal device to execute a discovery process, to determine a target second terminal device used for positioning.

An embodiment of this application provides an information processing method, including:
transmitting, by a second network device, first information to a first network device, where the first information is used to request positioning, and the first information is related to a first application that requests a location of a first terminal device.

An embodiment of this application provides an information processing method, including:
receiving, by a first terminal device, second information, where the second information is used to trigger the first terminal device to execute a discovery process, to determine a target second terminal device used for positioning.

An embodiment of this application provides an information processing method, including:
receiving, by a second terminal device, second information, where the second information is used to trigger the second terminal device to execute a discovery process with a first terminal device, to determine a target second terminal device used for positioning

An embodiment of this application provides a first network device, including:
a first communications unit, configured to: receive first information, where the first information is used to request positioning; and transmit second information, where the second information is used to trigger the first terminal device to execute a discovery process, to determine a target second terminal device used for positioning.

An embodiment of this application provides a second network device, including:
a second communications unit, configured to transmit first information to a first network device, where the first information is used to request positioning, and the first information is related to a first application that requests a location of a first terminal device.

An embodiment of this application provides a first terminal device, including:
a third communications unit, configured to receive second information, where the second information is used to trigger the first terminal device to execute a discovery process, to determine a target second terminal device used for positioning.

An embodiment of this application provides a second terminal device, including:
a fourth communications unit, configured to receive second information, where the second information is used to trigger the second terminal device to execute a discovery process with a first terminal device, to determine a target second terminal device used for positioning.

An embodiment of this application provides a terminal device, including a processor and a memory. The memory is configured to store a computer program, and the processor is configured to invoke and run the computer program stored in the memory, to cause the terminal device to execute the foregoing information processing methods.

An embodiment of this application provides a network device, including a processor and a memory. The memory is configured to store a computer program, and the processor is configured to invoke and run the computer program stored in the memory, to cause the network device to execute the foregoing information processing methods.

An embodiment of this application provides a chip, configured to implement the foregoing information processing methods. Specifically, the chip includes a processor, configured to invoke a computer program from a memory and run the computer program, to cause a device on which the chip is installed to execute the foregoing information processing methods.

An embodiment of this application provides a computer-readable storage medium, configured to store a computer program. When being run by a device, the computer program causes the device to execute the foregoing information processing methods.

An embodiment of this application provides a computer program product, including computer program instructions, where the computer program instructions cause a computer to execute the foregoing information processing methods.

An embodiment of this application provides a computer program. When being run on a computer, the computer program causes the computer to execute the foregoing information processing methods.

An embodiment of this application provides a communications system, including a terminal device configured to execute the foregoing information processing methods, and a network device configured to execute the foregoing information processing methods.

### BRIEF DESCRIPTION OF DRAWINGS

FIG. 1 is a schematic diagram of an application scenario according to an embodiment of this application.

FIG. 2 is a schematic diagram of a scenario in which a terminal device establishes a direct communication connection.

FIG. 3 and FIG. 4 are schematic diagrams of two modes of a short-range discovery operation.

FIG. 5 is a schematic flowchart of an information processing method according to an embodiment of this application.

FIG. 6 is a schematic flowchart of an information processing method according to another embodiment of this application.

FIG. 7 is a schematic flowchart of an information processing method according to still another embodiment of this application.

FIG. 8 is a schematic flowchart of an information processing method according to yet another embodiment of this application.

FIG. 9 is a schematic diagram of a processing scenario of an information processing method according to still yet another embodiment of this application.

FIG. 10A and FIG. 10B are processing flowcharts of a plurality of examples of an information processing method according to an embodiment of this application.

FIG. 11 to FIG. 12 are processing flowcharts of a plurality of examples of an information processing method according to an embodiment of this application.

FIG. 13 is a schematic block diagram of a first network device according to an embodiment of this application.

FIG. 14 is a schematic block diagram of a second network device according to an embodiment of this application.

FIG. 15 is a schematic block diagram of a first terminal device according to another embodiment of this application.

FIG. 16 is a schematic block diagram of a second terminal device according to another embodiment of this application.

FIG. 17 is a schematic block diagram of a communications device according to an embodiment of this application.

FIG. 18 is a schematic block diagram of a chip according to an embodiment of this application.

FIG. 19 is a schematic block diagram of a communications system according to an embodiment of this application.

### DESCRIPTION OF EMBODIMENTS

The following describes the technical solutions in embodiments of this application in combination with the accompanying drawings in embodiments of this application.

The technical solutions in embodiments of this application may be applied to various communications systems, for example, a global system for mobile communications (GSM), a code division multiple access (CDMA) system, a wideband code division multiple access (WCDMA) system, general packet radio service (GPRS), a long-term evolution LTE) system, an advanced long-term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial networks (NTN) system, a universal mobile telecommunications system (UMTS), a wireless local area network (WLAN), wireless fidelity (WiFi), a 5th-generation (5G) system, or another communications system.

Generally, a quantity of connections supported by a conventional communications system is limited and is also easy to implement. However, with development of communication technologies, a mobile communications system not only supports conventional communication, but also supports, for example, device-to-device (D2D) communication, machine to machine (M2M) communication, machine-type communication (MTC), vehicle-to-vehicle (V2V) communication, or vehicle-to-everything (V2X) communication. Embodiments of this application may also be applied to these communications systems.

In an implementation, a communications system in embodiments of this application may be applied to a carrier aggregation (CA) scenario, a dual connectivity (DC) scenario, or a standalone (SA) networking scenario.

In an implementation, a communications system in embodiments of this application may be applied to an unlicensed spectrum, and the unlicensed spectrum may also be considered as a shared spectrum. Alternatively, a communications system in embodiments of this application may be applied to a licensed spectrum, and the licensed spectrum may also be considered as a non-shared spectrum.

Embodiments of this application are described with reference to a network device and a terminal device. The terminal device may also be referred to as a user equipment (UE), an access terminal, a subscriber unit, a subscriber station, a mobile site, a mobile station, a remote station, a remote terminal, a mobile device, a user terminal, a terminal, a wireless communications device, a user agent, a user apparatus, or the like.

The terminal device may be a station (ST) in a WLAN, a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, a terminal device in a future evolved public land mobile network (PLMN), or the like.

In embodiments of this application, the terminal device may be deployed on land, including being indoors or outdoors, handheld, wearable, or vehicle-mounted. The terminal device may also be deployed on water (for example, on a ship), or may be deployed in the air (for example, on an airplane, an air balloon, or a satellite).

In embodiments of this application, the terminal device may be a mobile phone, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, or the like.

By way of example rather than limitation, in embodiments of this application, the terminal device may alternatively be a wearable device. The wearable device may also be referred to as an intelligent wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, wearable smart devices may include a full-featured and large-sized device that can provide full or partial functions without relying on a smart phone, for example, a smart watch or smart glasses, and devices that focus on only a specific type of application function and need to cooperate with another device such as a smart phone for use, for example, various smart bracelets and smart jewelries for physical sign monitoring.

In embodiments of this application, the network device may be a device configured to communicate with a mobile device. The network device may be an access point (AP) in a WLAN, a base transceiver station (BTS) in GSM or CDMA, a Node B (NB) in WCDMA, an evolved Node B (eNB, or eNodeB) in LTE, a relay station or an access point, a vehicle-mounted device, a wearable device, a network device (gNB) in an NR network, a network device in a future evolved PLMN network, a network device in an NTN network, or the like.

By way of example rather than limitation, in embodiments of this application, the network device may have a mobility characteristic. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell. The small cell herein may include a metro cell, a micro cell, a pico cell, a femto cell, or the like. These small cells have a characteristic of a small coverage range and low transmit power, and are applicable to providing a high-rate data transmission service.

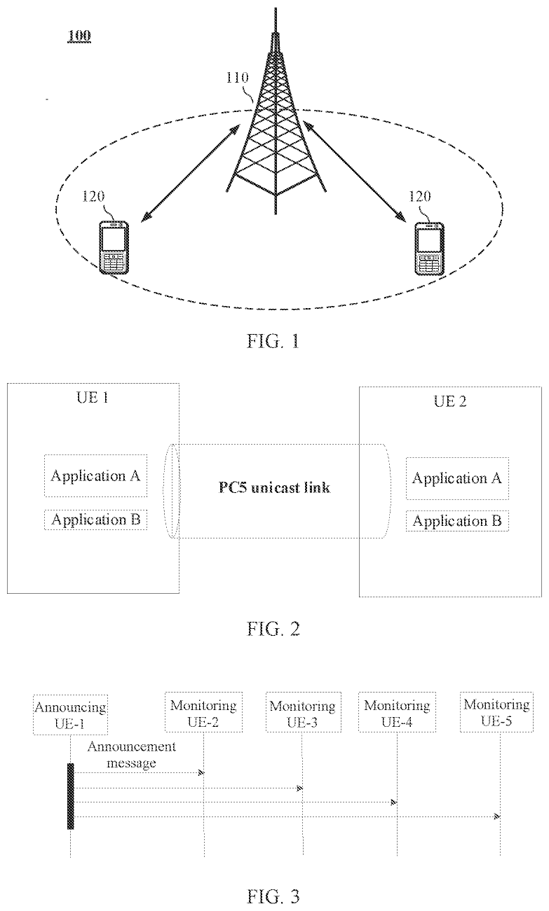

FIG. 1 exemplarily shows a communications system 100. The communications system includes one network device 110 and two terminal devices 120. In an implementation, the communications system 100 may include a plurality of network devices 110, and another quantity of terminal devices 120 may be included within a coverage range of each network device 110, which is not limited in embodiments of this application.

In an implementation, the communications system 100 may further include another network entity such as a mobility management entity (MME) or an access and mobility management function (AMF), which is not limited in embodiments of this application.

The network device may further include an access network device and a core network device. That is, the wireless communications system further includes a plurality of core networks configured to communicate with the access network device. The access network device may be an evolved Node B (which may be an eNB or an e-NodeB for short), a macro base station, a micro base station (also referred to as a “small cell”), a pico base station, an access point (AP), a transmission point (TP), or a new-generation Node B (gNodeB), or the like in a long-term evolution (LTE) system, a next-generation (mobile communications system) (next radio, NR) system, or an authorized auxiliary access long-term evolution (LAA-LTE) system.

To facilitate understanding of the technical solutions in embodiments of this application, the following describes related technologies in embodiments of this application. The following related technologies may be randomly combined with the technical solutions in embodiments of this application as optional solutions, which are all within the protection scope of embodiments of this application.

ProSe (Proximity-based Services) architecture: A UE having a short-range communication capability may establish a connection to another UE having a short-range communication capability by using a PC5 radio interface, to perform direct communication. As shown in FIG. 2, a UE1 and a UE2 are two UEs that have a short-range communication capability. The UE1 and the UE2 may establish a unicast link (that is, the PC5 unicast link in FIG. 2) by using a PC5 (that is, direct connection communications) interface, to perform direct communication. The direct communication between the UE1 and the UE2 may be specifically triggered by an application installed in the UE1 or the UE2. For example, FIG. 2 shows that an application A and an application B are installed in the UE1, and the application A and the application B are also installed in the UE2. The application A in the UE1 may trigger direct communication with the application A in the UE2.

Before two UEs perform short-range communication, a UE that has a short-range communication capability may also first perform a short-range discovery operation, to discover other UEs adjacent to the UE, thereby selecting a proper target UE to establish a direct communication connection with the UE. As shown in FIG. 3, in a direct discovery mode A, a UE-1 (that is, the announcing UE-1 in FIG. 3) may broadcast an announcement message, where the announcement message may include information about a service or an application, and the like. Monitoring UEs (that is, the monitoring UE-2 to the monitoring UE-5 shown in FIG. 3) may separately obtain information about the UE-1 according to the announcement message obtained through monitoring, and may select the UE-1 to establish a short-range connection. As shown in FIG. 4, in a direct discovery mode B, a UE-1 (that is, the discoverer UE-1 shown in FIG. 4) may broadcast a discovery request message, where the request message may include information about a discovery target. Correspondingly, after receiving the request message, UEs near the UE-1 (that is, the discoveree UE-2 to the discoveree UE-5 shown in FIG. 4) respond to the UE-1 (for example, the discoveree UE-2 and the discoveree UE-3 in FIG. 4 feed back response messages to the discoverer UE-1) if the message may be matched.

It should be understood that in embodiments of this application, a device having a communication function in a network or a system may be referred to as a communications device. The communications system shown in FIG. 1 is used as an example. The communications device may include a network device and a terminal device that have a communication function. The network device and the terminal device may be specific devices in embodiments of this application. Details are not described herein again. The communications device may further include other devices in the communications system, such as a network controller and a mobility management entity, which is not limited in embodiments of this application.

It should be understood that the terms “system” and “network” may often be used interchangeably in this specification. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, the “indication” mentioned in embodiments of this application may be a direct indication or an indirect indication, or indicate an association. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association between A and B.

In the descriptions of embodiments of this application, the term “corresponding” may mean that there is a direct or indirect correspondence between two elements, or that there is an association between two elements, or that there is a relationship of “indicating” and “being indicated”, “configuring” and “being configured”, or the like.

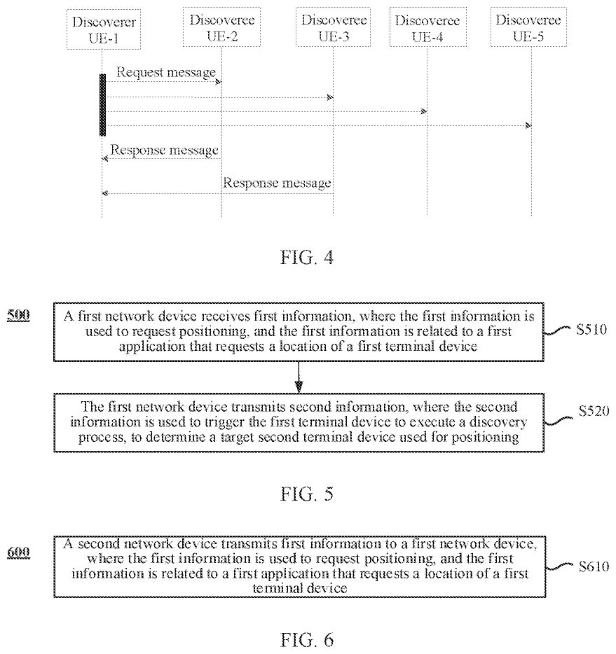

FIG. 5 is a schematic flowchart of an information processing method 500 according to an embodiment of this application. The method includes at least a part of the following content.

S510: A first network device receives first information, where the first information is used to request positioning, and the first information is related to a first application that requests a location of a first terminal device.

S520: The first network device transmits second information, where the second information is used to trigger the first terminal device to execute a discovery process, to determine a target second terminal device used for positioning.

FIG. 6 is a schematic flowchart of an information processing method 600 according to an embodiment of this application. The method includes at least a part of the following content.

S610: A second network device transmits first information to a first network device, where the first information is used to request positioning, and the first information is related to a first application that requests a location of a first terminal device.

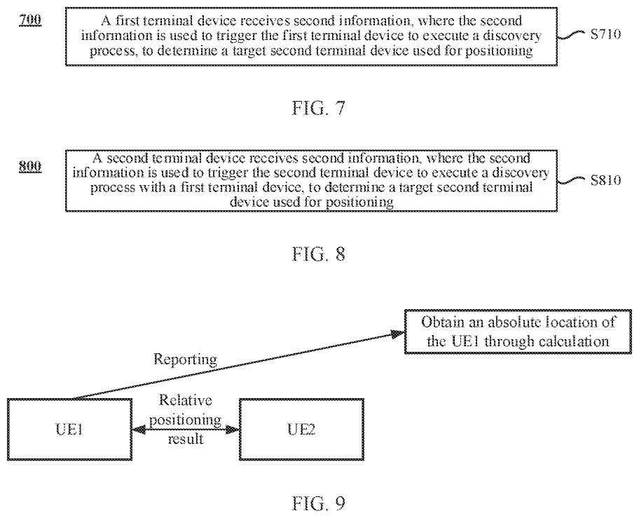

FIG. 7 is a schematic flowchart of an information processing method 700 according to an embodiment of this application. The method includes at least a part of the following content.

S710: A first terminal device receives second information, where the second information is used to trigger the first terminal device to execute a discovery process, to determine a target second terminal device used for positioning.

FIG. 8 is a schematic flowchart of an information processing method 800 according to an embodiment of this application. The method includes at least a part of the following content.

S810: A second terminal device receives second information, where the second information is used to trigger the second terminal device to execute a discovery process with a first terminal device, to determine a target second terminal device used for positioning.

In embodiments of this application, the first network device and the second network device may be core network devices. In a preferred example, the first network device may be an LMF entity, and the second network device may be an AMF (Access and Mobility Management Function) entity.

In embodiments provided in this application, the first application may be a third-party application, and the first application may be a third-party application installed in the first terminal device. It should be understood that this application does not rule out the possibility that the first application may be a third-party application installed in another terminal device except the first terminal device, provided that a scenario in which the first application requests to obtain a location of the first terminal device is within the protection scope of embodiments of this application. A reason why the first application requests the location of the first terminal device is not limited in this embodiment.

When needing to know the location of the first terminal device, the first application may transmit a first positioning request to a fourth network device by using an application server corresponding to the first application. The first positioning request carries at least an original identity of the first application and an identity of the first terminal device. The application server may be specifically an AF (Application Function). The fourth network device may be a core network device, for example, may be a gateway mobile location center (GMLC).

After receiving the first positioning request, the fourth network device obtains an identity of the first application based on the original identity of the first application included in the first positioning request, generates a positioning request based on the Identity of the first application and the identity of the first terminal device, and transmits the positioning request to the second network device.

In a case in which the first application is an external application, the identity of the first application is obtained through mapping based on the original identity of the first application. Specifically, in the case in which the first application is an external application, the identity of the first application is obtained by the fourth network device through mapping based on the original identity of the first application. Herein, the identity of the first application may refer to an identity of the first application in 3GPP (3rd Generation Partnership Project). In some examples, the identity of the first application may also be referred to as an internal identity of the first application, an identity of the first application inside 3GPP, or an identity of the first application within 3GPP, which is not enumerated exhaustively herein.

Specifically, after receiving the first positioning request, the fourth network device determines whether the original identity of the first application carried in the first positioning request is an ID of an internal application or an ID of an external application. If it is determined that the original identity of the first application is an ID of an internal application, the original identity of the first application is directly used as the identity of the first application used for subsequent processing; or if it is determined that the original identity of the first application is an ID of an external application, the original identity of the first application is mapped to the identity of the first application.

A manner in which the fourth network device determines whether the original identity of the first application carried in the first positioning request is an ID of an internal application or an ID of an external application may include: the fourth network device determines, based on a type of an application server, whether the original identity of the first application carried in the first positioning request is an ID of an internal application or an ID of an external application. In a case in which the first positioning request is transmitted by an internal server, the fourth network device may determine that the ID carried in the first positioning request is an ID of an internal application. Otherwise, the fourth network device determines that the ID carried in the first positioning request is an ID of an external application.

That the fourth network device maps the original identity of the first application to the identity of the first application may be: mapping the original identity of the first application to the identity of the first application according to a preset mapping table of the fourth network device. The mapping table may include an original ID of each external application in a plurality of external applications and a mapping relationship between IDs of the external applications in 3GPP.

Correspondingly, before executing S610, the second network device may further execute the following processing: receiving a positioning request transmitted by the fourth network device, where the positioning request carries the identity of the first terminal device and the identity of the first application. The second network device may be an AMF entity.

After receiving the positioning request, the second network device may determine a first network device from a plurality of candidate first network devices. Herein, determining a first network device from a plurality of candidate first network devices may refer to: selecting a first network device that can locate the first terminal device from the plurality of candidate first network devices. For example, the second network device may perform the selection according to whether different candidate first network devices support a positioning capability, and/or whether the first terminal device is located within a coverage range of a candidate first network device, and/or other relevant parameters of a candidate first network device, and/or selection of a default first network device. For example, currently, there are three candidate first network devices. If a candidate first network device 1 does not support positioning, the candidate first network device 1 is not selected. The remaining candidate first network devices 2 and 3 support positioning, but a location of the candidate first network device 2 is more suitable for positioning the first terminal device than a location of the candidate first network device 3. In this case, the candidate first network device 2 may be selected as the first network device. It should be understood that this is merely an example for description. In embodiments of this application, all possible manners of selecting the first network device are not enumerated exhaustively.

After determining the first network device, the second network device may execute S610, that is, the second network device transmits the first information to the first network device. Correspondingly, the first network device executes S510, that is, the first network device receives the first information. Specifically, the first network device receives the first information transmitted by the second network device. The first information carries the identity of the first terminal device and the identity of the first application.

After the first network device receives the first information, the method further includes: obtaining, by the first network device, related information of an area in which the first terminal device is located from the second network device; and determining, by the first network device, one or more second terminal devices based on the related information of the area in which the first terminal device is located, where the one or more second terminal devices are located in the same area as the first terminal device.

The first network device may obtain, based on the identity of the first terminal device, the related information of the area in which the first terminal device is located from the second network device. The related information of the area in which the first terminal device is located includes at least one of the following: a tracking area identity (TAI) of the area in which the first terminal device is located, or a cell ID of the area in which the first terminal device is located.

The determining, by the first network device, one or more second terminal devices based on the related information of the area in which the first terminal device is located may be specifically: determining, by the first network device, one or more second terminal devices that have the same TAI and/or the same cell ID as the area in which the first terminal device is located based on the TAI and/or the cell ID of the area in which the first terminal device is located.

Herein, the one or more second terminal devices may be at least some of all candidate second terminal devices pre-saved in the first network device. When all the candidate second terminal devices are pre-saved in the first network device, the first network device saves a TAI and/or a cell ID of an area in which each candidate second terminal device is located. A reason why the first network device can pre-save the TAI and/or the cell ID of the area in which each candidate second terminal device is located is: before executing this embodiment of this application, the first network device may obtain and save the TAI and/or the cell ID of the area in which each candidate second terminal device is located based on any time of or a plurality of times of executing a positioning procedure of a Uu interface or another positioning-related procedure. A specific obtaining manner is not limited in this embodiment.

Optionally, the obtaining, by the first network device, related information of an area in which the first terminal device is located from the second network device; and determining, by the first network device, one or more second terminal devices based on the related information of the area in which the first terminal device is located may further specifically include:
after receiving the first information, the first network device may first execute a positioning procedure based on a Uu interface, to locate the first terminal device and obtain the location of the first terminal device, determine whether the location of the first terminal device meets a precision requirement, and if the location of the first terminal device meets the precision requirement, end the processing; or,
if the location of the first terminal device does not meet the precision requirement, the first network device obtains the related information of the area in which the first terminal device is located from the second network device, and the first network device determines one or more second terminal devices based on the related information of the area in which the first terminal device is located, where the one or more second terminal devices are located in the same area as the first terminal device.

That is, the first network device may first execute a positioning procedure of a Uu interface on the first terminal device. If the location of the first terminal device that is obtained based on the positioning procedure meets the precision requirement, the first network device may directly transmit the location of the first terminal device to the application server corresponding to the first application, and end the processing. If the location of the first terminal device that is obtained based on the positioning procedure does not meet the precision requirement or the first terminal device cannot be located, the following processing may be executed: the first network device obtains the related information of the area in which the first terminal device is located from the second network device, and determines one or more second terminal devices based on the related information of the area in which the first terminal device is located. A specific implementation of the positioning procedure based on a Uu interface is not limited in this embodiment. The precision requirement may be carried in the first positioning request, and may also be carried in a positioning request transmitted by the second network device to the first network device. The precision requirement may refer to positioning precision at a latitude and longitude level, and is not limited herein.

After determining the one or more second terminal devices, the first network device may execute S520, that is, the first network device transmits second information, where the second information is used to trigger the first terminal device to execute a discovery process, to determine a target second terminal device used for positioning.

The second information carries at least one of the following: the identity of the first terminal device; the identity of the first application; or an identity of each second terminal device in the one or more second terminal devices. The second information is further used to request discovery of a second terminal device that supports positioning. That is, the second information is specifically used to trigger the first terminal device to execute a discovery process with the one or more second terminal devices, to determine the target second terminal device used for positioning.

In a preferred example, the second information may carry all the foregoing content. Certainly, more content may be further carried depending on different actual requirements, which is not enumerated exhaustively in this embodiment.

A manner in which the first network device generates the second information may be: the first network device carries the identity of the first application and the identity of the first terminal device that are included in the positioning request in the second information, and the first network device carries the identity corresponding to the selected one or more second terminal devices in the second information, to generate the second information. In addition, the first network device may further carry request information used to request discovery of a second terminal device (that is, request discovery of a second terminal device that supports positioning) in the second information.

The first network device may execute S520 in a plurality of implementations. For example, the first network device may separately transmit the second information to the first terminal device and each second terminal device in the one or more second terminal devices. Alternatively, the first network device may transmit the second information to a third network device.

In some possible implementations, that the first network device transmits second information includes: the first network device separately transmits the second information to the first terminal device and each second terminal device in the one or more second terminal devices.

On a side of the first terminal device, S710 may be executed, that is, the first terminal device receives second information, where the second information is used to trigger the first terminal device to execute a discovery process, to determine a target second terminal device used for positioning. Similarly, on a side of the second terminal device, S810 may be executed, that is, the second terminal device receives second information. It should be noted that the second terminal device may be any one of one or more second terminal devices selected by the first network device, that is, each second terminal device in the one or more second terminal devices selected by the first network device may execute the foregoing processing, which is not described again.

Optionally, that the first terminal device receives second information may specifically refer to: the first terminal device receives the second information transmitted by the first network device. Similarly, that the second terminal device receives second information may be: the second terminal device receives the second information transmitted by the first network device.

Further, on the side of the first terminal device, after the second information is received, the following processing may be further executed: the first terminal device executes a discovery process, to obtain a discovered second terminal device, and the first terminal device transmits reply information for the second information, where the reply information for the second information is used to indicate the second terminal device discovered by the first terminal device. Similarly, on the side of the second terminal device, after the second information is received, the following processing may be executed: the second terminal device executes a discovery process with the first terminal device.

That the first terminal device executes a discovery process, to obtain a discovered second terminal device includes:
the first terminal device transmits fifth information to a third network device, where the fifth information is used to request the third network device to generate application code used for discovery; the first terminal device receives reply information for the fifth information that is transmitted by the third network device, where the reply information for the fifth information carries the application code used for discovery; and the first terminal device executes discovery processing based on the application code, to obtain the discovered second terminal device.

The fifth information carries at least one of the following: the identity of the first application, the identity of the first terminal device, or the identity of each second terminal device in the one or more second terminal devices. In a preferred example, the fifth information carries all the foregoing content. The reply information for the fifth information may further carry at least one of the following: the identity of the first application, the identity of the first terminal device, or the identity of each second terminal device in the one or more second terminal devices. In a preferred example, the reply information for the fifth information carries all the foregoing content.

After receiving the fifth information, the third network device may generate, based on the identity of the first application, the application code used for discovery. It should be understood that the third network device may also generate the application code used for discovery with reference to at least part of the identity of the first terminal device and the identity of each second terminal device in the one or more second terminal devices, which are both within the protection scope of this embodiment. Herein, the third network device may be a direct discovery name management function (DDNMF) entity. A manner in which the third network device generates the application code used for discovery is not limited in this embodiment.

That the second terminal device executes a discovery process with the first terminal device may include: the second terminal device transmits sixth information to the third network device, where the sixth information is used to request the third network device to generate the application code used for discovery; the second terminal device receives reply information for the sixth information that is transmitted by the third network device, where the reply information for the sixth information carries the application code used for discovery; and the second terminal device executes the discovery process with the first terminal device based on the application code.

The sixth information carries at least one of the following: the identity of the first application, the identity of the first terminal device, or the identity of each second terminal device in the one or more second terminal devices. In a preferred example, the sixth information carries all the foregoing content. The reply information for the sixth information may further carry at least one of the following: the identity of the first application, the identity of the first terminal device, or the identity of each second terminal device in the one or more second terminal devices. In a preferred example, the reply information for the sixth information carries all the foregoing content.

After receiving the sixth information, the third network device may generate, based on the identity of the first application, the application code used for discovery. It should be understood that the third network device may also generate the application code used for discovery with reference to at least part of the identity of the first terminal device and the identity of each second terminal device in the one or more second terminal devices, which are both within the protection scope of this embodiment.

The foregoing processing of executing a discovery process by the first terminal device and the second terminal device may use the discovery mode A or the discovery mode B. Specific processing of a discovery process is not limited in this embodiment. Specifically, whether the discovery process is executed by using the discovery mode A or the discovery mode B in a current time may be determined at a time when the third network device generates the application code used for discovery. Alternatively, when transmitting the fifth information, the first terminal device may carry information related to the discovery mode used in the current time in the fifth information. The information related to the discovery mode may refer to an index number, an identifier, or a name of the discovery mode.

After the first terminal device executes the discovery process with the one or more second terminal devices, the second terminal device discovered by the first terminal device may be obtained. After obtaining the discovered second terminal device, the first terminal device may further execute the following processing: the first terminal device transmits reply information for the second information. Specifically, that the first terminal device transmits reply information for the second information may be: the first terminal device transmits the reply information for the second information to the first network device.

The reply information for the second information carries an identity of the second terminal device discovered by the first terminal device and the identity of the first application. Herein, the identity of the second terminal device discovered by the first terminal device refers to an identity of each discovered second terminal device in one or more second terminal devices discovered by the first terminal device. Herein, the one or more second terminal devices discovered by the first terminal device are specifically one or more second terminal devices that support positioning and that are discovered by the first terminal device.

On a side of the first network device, processing that may be executed includes: the first network device receives reply information for the second information, where the reply information for the second information is used to indicate a second terminal device discovered by the first terminal device; the first network device determines, from the second terminal device discovered by the first terminal device, a target second terminal device used for positioning; the first network device transmits third information, where the third information is used to instruct the first terminal device to perform positioning with the target second terminal device, and the third information carries a positioning-related parameter; and the first network device receives a relative positioning result, and determines location information of the first terminal device based on the relative positioning result, where the relative positioning result is a relative location relationship between the first terminal device and the target second terminal device.

After obtaining the location information of the first terminal device, the first network device may return the location information of the first terminal device to the application server corresponding to the first application.

That the first network device determines, from the second terminal device discovered by the first terminal device, a target second terminal device used for positioning may refer to: the first network device randomly selects one from one or more second terminal devices discovered by the first terminal device (that is, one or more second terminal devices that support positioning and that are discovered by the first terminal device) as the target second terminal device used for positioning; or, the first network device may select, from one or more second terminal devices discovered by the first terminal device, one closest to the first terminal device as the target second terminal device used for positioning. Herein, the first network device pre-saves location information of a terminal device (which may be an absolute location of the terminal device). Therefore, before transmitting the second information, the first network device may first execute Uu-based positioning processing with the first terminal device. Based on the positioning processing, the location of the first terminal device may be obtained. The location may not be accurate, but the location may be used to select the second terminal device closest to the first terminal device as the target second terminal device used for positioning.

That the first network device transmits third information may be specifically: the first network device transmits the third information to the first terminal device, and the first network device transmits the third information to the target second terminal device. The third information is used to instruct the first terminal device to perform positioning with the target second terminal device, and the third information carries a positioning-related parameter. The positioning-related parameter may include at least one of the following: a relative distance, a relative location, a relative direction, precision, or the like. The precision may include at least one of the following: precision of a relative distance, precision of a relative location, or precision of a relative direction. In a preferred example, the positioning-related parameter includes all the foregoing content, that is, the first network device notifies the first terminal device to perform positioning with the target second terminal device. Specifically, a relative distance, a relative location, and a relative direction need to be obtained. In addition, the relative distance has corresponding precision, the relative location has corresponding precision, and the relative direction also has corresponding precision. It should be understood that this is merely an example for description of the positioning-related parameter, which does not represent a limitation on the positioning-related parameter.

Correspondingly, processing of the first terminal device may include: the first terminal device receives third information transmitted by the first network device, where the third information is used to instruct the first terminal device to perform positioning with the target second terminal device, and the third information carries a positioning-related parameter; the first terminal device performs positioning processing with the target second terminal device, to obtain a relative positioning result; and the first terminal device transmits the relative positioning result to the first network device, where the relative positioning result is used to determine the location information of the first terminal device, and the relative positioning result is a relative location relationship between the first terminal device and the target second terminal device.

Processing of the second terminal device may include: in a case in which the second terminal device receives the third information transmitted by the first network device, the second terminal device determines the target second terminal device that performs positioning as the first terminal device, where the third information is used to instruct the first terminal device to perform positioning with the target second terminal device, and the third information carries a positioning-related parameter; and the second terminal device performs positioning processing with the first terminal device, to obtain a relative positioning result, where the relative positioning result is used to determine the location information of the first terminal device, and the relative positioning result is a relative location relationship between the first terminal device and the target second terminal device. Herein, the relative positioning result may include at least one of a relative distance, a relative angle, or a relative direction between the first terminal device and the target second terminal device.

In a possible case, after obtaining the relative positioning result, the second terminal device may save but does not report the relative positioning result, while the first terminal device reports the relative positioning result. In another possible case, the second terminal device may transmit the relative positioning result to the first network device. In still another possible case, the first terminal device and the second terminal device may negotiate about which of them reports the relative positioning result. For example, if it is indicated in the third information that the first terminal device performs positioning in a current time, the first terminal device reports the relative positioning result by default. For another example, if it is not indicated in the third information that the first terminal device performs positioning in a current time, the first terminal device and the second terminal device may negotiate with each other, to determine whether the first terminal device or the second terminal device reports the relative positioning result. A specific negotiation process is not limited in this embodiment. In another possible case, in a case in which the first terminal device is within a coverage range of a cell (or referred to as a coverage range of a network), the first terminal device reports the relative positioning result. In a case in which the first terminal device is not within a coverage range of a cell, the first terminal device may instruct the second terminal device to report the relative positioning result. In this case, the second terminal device reports the relative positioning result.

That the first network device receives a relative positioning result, and determines location information of the first terminal device based on the relative positioning result may refer to: the first network device may receive the relative positioning result from the first terminal device and/or the second terminal device; and then the first network device determines the location information of the first terminal device based on the relative positioning result.

Specifically, that the first network device determines the location information of the first terminal device based on the relative positioning result may refer to: the first network device obtains the location information of the first terminal device through calculation according to the relative positioning result and an absolute location of the target second terminal device, where the location information of the first terminal device may refer to an absolute location of the first terminal device. In this embodiment, the absolute location may be represented by using a longitude and a latitude.

For example, referring to FIG. 9, it is assumed that a first network device is an LMF, a first terminal device is represented as a UE1, and a target second terminal device is represented as a UE2. When the LMF cannot locate the UE1 by using a Uu interface and in an existing positioning manner, or precision of the located UE1 is insufficient, the LMF may accurately locate the UE2 (that is, the LMF saves an absolute location of the UE2). In this case, the LMF may obtain an absolute location of the UE1 through calculation by using a relative positioning result between the UE1 and the UE2 and the absolute location of the UE2. The relative positioning result between the UE1 and the UE2 may be implemented based on a ranging (initial ranging) or a sidelink (SL) positioning technology. The ranging or sidelinkpositioning technology may refer to: determining, by using a PC5 interface, a distance between two or more terminals and/or a direction and/or a relative location between one terminal (that is, a target terminal) and another terminal (that is, a reference terminal). A manner in which the LMF obtains a relative location between the UE1 and the UE2 may be: when the UE1 is within network coverage, the relative location is reported to the LMF by using the UE1; or when the UE1 is not within network coverage, the relative location may be reported to the LMF by using the UE2.

In this embodiment, an application server provides an application (APP) ID for the first network device (that is, the LMF). By transmitting the APP ID to terminal devices, the first network device triggers the first terminal device to execute a discovery process with one or more second terminal devices based on a ProSe discovery procedure. This ensures normal execution of a subsequent positioning process.

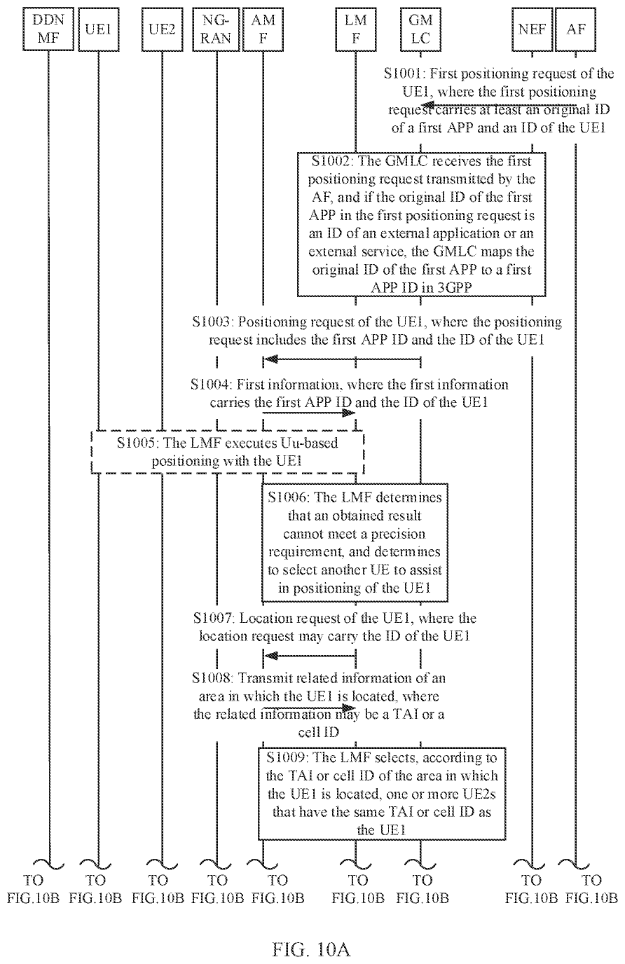

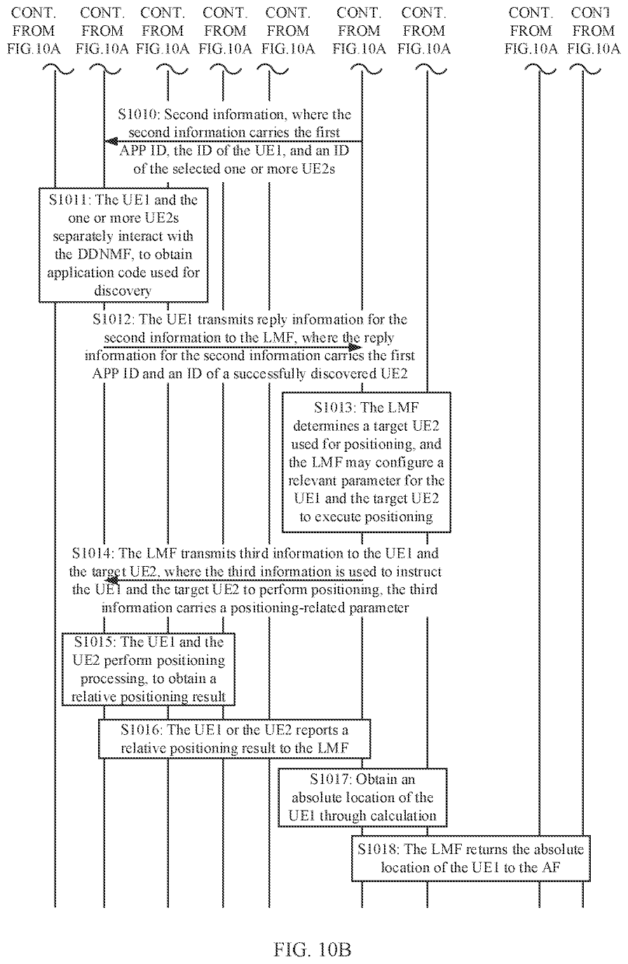

With reference to FIG. 10A and FIG. 10B, the processing provided in the foregoing implementations is described by using the following example: a first terminal device is a UE1, a second terminal device (the second terminal device may be a second terminal device discovered by the first terminal device or a target second terminal device used for positioning that is determined by a first network device) is a UE2, the first network device is an LMF, a second network device is an AMF, a third network device is a DDNMF, a fourth network device is a GMLC, and an application server is an AF.

S1001: When a first application (APP) wants to know a location of the UE1, the AF corresponding to the first application transmits a first positioning request of the UEI to the GMLC. The first positioning request carries at least an original ID of the first APP and an ID of the UE1.

If the AF is an external AF, the first positioning request is transmitted to the GMLC by using the NEF (Network Exposure Function) shown in FIG. 10A and FIG. 10B. The first positioning request needs to include the original ID of the first APP, and the original ID of the first APP represents an APP that wants to know the location of the UE1.

S1002: The GMLC receives the first positioning request transmitted by the AF, and if the original ID of the first APP in the first positioning request is an ID of an external application or an external service, the GMLC maps the original ID of the first APP to a first APP ID in 3GPP.

If the first application is an internal application, the original ID of the first APP is directly used as the first APP ID for internal use; or if the first application is an external application, the original ID of the first APP is mapped to the internal first APP ID.

S1003: The GMLC transmits the first positioning request of the UEI to the AMF, where the positioning request includes the first APP ID and the ID of the UE1.

S1004: The AMF transmits first information to the LMF, where the first information carries the first APP ID and the ID of the UE1.

The AMF may first determine the LMF that may locate the UE1, and then transmit the first information to the LMF. Detailed descriptions of the first information are the same as those in the foregoing embodiments, and details are not described herein again.

S1005: If the UE1 is within network coverage, the LMF first executes a Uu-based positioning procedure, to obtain a location of the UE1.

S1006: The LMF determines that a result cannot meet a precision requirement, and determines to select another UE to assist in positioning of the UE1.

S1007: To select a proper UE to assist in the positioning of the UE1, the LMF transmits a location request of the UE1 to the AMF, where the location request may carry the ID of the UE1.

S1008: The AMF transmits, to the LMF, related information of an area in which the UE1 is located, where the related information may be a TAI or a cell ID.

S1009: The LMF selects, according to the TAI or cell ID of the area in which the UE1 is located, one or more UE2s that have the same TAI or cell ID as the UE1.

Herein, the LMF may store the TAI or cell ID of the UE2s in advance, or the LMF may perform Uu-based positioning with the UE2s before this procedure, which is not limited in this solution. The UE2s have a more precise positioning result based on Uu.

S1010: The LMF transmits second information to the UE1 and the selected one or more UE2s, where the second information carries the first APP ID, the ID of the UE1, and an ID of the selected one or more UE2s. The second information may also be referred to as a discovery request, and further includes a ranging discovery indication, which indicates that a UE that may support ranging needs to be discovered. Detailed descriptions of the second information are the same as those in the foregoing embodiments, and details are not described herein again.

S1011: The UE1 and the one or more UE2s separately interact with the DDNMF, to obtain application code used for discovery.

Processing of separately obtaining the application code used for discovery by the UE1 and the UE2s is the same as that in the foregoing embodiments, and details are not described herein again.

S1012: After the UE1 successfully discovers the one or more UE2s, the UE1 transmits reply information for the second information to the LMF, where the reply information for the second information carries the first APP ID and the ID of the successfully discovered UE2s.

S1013: The LMF determines a target UE2 used for positioning, and the LMF may configure a relevant parameter for the UE1 and the target UE2 to execute positioning.

S1014: The LMF transmits third information to the UE1 and the target UE2, where the third information is used to instruct the UE1 and the target UE2 to perform positioning, the third information carries a positioning-related parameter, and the positioning-related parameter may include, for example, a relative distance, a relative location, a relative direction, and precision.

S1015: The UE1 and a UE2 perform positioning processing, to obtain a relative positioning result. In this step, the UE2 refers to the target UE2. The positioning processing may be executing a ranging process.

S1016: The UE1 or a UE2 reports a relative positioning result to the LMF. The relative positioning result may also be referred to as a ranging result. In this step, the UE2 refers to the target UE2.

S1017: The LMF obtains an absolute location of the UE1 through calculation according to an absolute location of a UE2 and a relative location of the UE1. In this step, the UE2 refers to the target UE2.

S1018: The LMF returns the absolute location of the UEI to the AF.

FIG. 10A and FIG. 10B further show an access network device, that is, an NG-RAN. Although a function of the access network device is not described in the foregoing embodiments, a network side may transmit information to the UE1 or the UE2 by using the access network device. Transmission processing of the access network device is not described in detail.

In some possible implementations, before transmitting the second information, the first network device may first obtain application code used for discovery, and then carry the application code used for discovery in the second information.

Before the first network device transmits second information, the method further includes: transmitting, by the first network device, fourth information to a third network device, where the fourth information is used to request the third network device to generate application code used for discovery; and receiving, by the first network device, reply information for the fourth information that is transmitted by the third network device, where the reply information for the fourth information carries the application code used for discovery.

The fourth information carries at least one of the following: the identity of the first application, the identity of the first terminal device, or the identity of each second terminal device in the one or more second terminal devices. The reply information for the fourth information may further carry at least one of the following: the identity of the first application, the identity of the first terminal device, or the identity of each second terminal device in the one or more second terminal devices. In a preferred example, the fourth information carries all the foregoing content, and the reply information for the fourth information carries all the foregoing content.

A difference from the foregoing implementations lies in that: in the foregoing implementations, a first terminal device and a second terminal device separately transmit fifth information to a third network device, to request the third network device to generate application code used for discovery. In this implementation, a first network device directly transmits fourth information to a third network device, to request the third network device to generate application code used for discovery. The third network device may generate the application code used for discovery based on an ID of a first application. Herein, the third network device may be a DDNMF entity. A manner in which the third network device generates the application code used for discovery is not limited in this embodiment.

After receiving reply information for the fourth information that is transmitted by the third network device, the first network device obtains the application code used for discovery that is generated by the third network device. Then, the first network device may carry the application code used for discovery in the second information, and the first network device separately transmits the second information to the first terminal device and each second terminal device in the one or more second terminal devices.

That is, in this implementation, the second information is also different from that in the foregoing implementations. In this implementation, in addition to carrying at least one of the identity of the first terminal device, the identity of the first application, or the identity of each second terminal device in the one or more second terminal devices, the second information further carries the application code used for discovery.

Correspondingly, processing that may be executed by the first terminal device after receiving the second information includes: the first terminal device executes discovery processing based on the application code, to obtain a discovered second terminal device. Similarly, processing that may be executed by the second terminal device after receiving the second information includes: the second terminal device executes discovery processing with the first terminal device based on the application code.

Further, after the first terminal device and the second terminal device complete the discovery process, the first terminal device may obtain the discovered second terminal device, and then transmit reply information for the second information. Specifically, the first terminal device transmits the reply information for the second information to the first network device. Correspondingly, processing of the first network device includes: the first network device receives the reply information for the second information that is transmitted by the first terminal device. Content that may be carried in the reply information for the second information is the same as that in the foregoing embodiments, and both are the identity of the second terminal device discovered by the first terminal device and the identity of the first application. Details are not described herein again. The second terminal device discovered by the first terminal device may be one or more second terminal devices that support positioning and that are discovered by the first terminal device. The identity of the second terminal device discovered by the first terminal device may be specifically: an identity of each second terminal device in the one or more second terminal devices that support positioning and that are discovered by the first terminal device. Related descriptions of the second terminal device discovered by the first terminal device are the same as those in the foregoing embodiments, and details are not described again.

After the first network device receives the reply information for the second information, the first network device may execute the following processing: the first network device receives the reply information for the second information, where the reply information for the second information is used to indicate a second terminal device discovered by the first terminal device; the first network device determines, from the second terminal device discovered by the first terminal device, a target second terminal device used for positioning; the first network device transmits third information, where the third information is used to instruct the first terminal device to perform positioning with the target second terminal device, and the third information carries a positioning-related parameter; and the first network device receives a relative positioning result, and determines location information of the first terminal device based on the relative positioning result, where the relative positioning result is a relative location relationship between the first terminal device and the target second terminal device. Detailed descriptions are the same as those in the foregoing embodiments, and therefore details are not described again.

Correspondingly, processing of the first terminal device may include: the first terminal device receives third information transmitted by the first network device, where the third information is used to instruct the first terminal device to perform positioning with the target second terminal device, and the third information carries a positioning-related parameter; the first terminal device performs positioning processing with the target second terminal device, to obtain a relative positioning result; and the first terminal device transmits the relative positioning result to the first network device, where the relative positioning result is used to determine the location information of the first terminal device, and the relative positioning result is a relative location relationship between the first terminal device and the target second terminal device.

Processing of the second terminal device may include: in a case in which the second terminal device receives the third information transmitted by the first network device, the second terminal device determines the target second terminal device that performs positioning as the first terminal device, where the third information is used to instruct the first terminal device to perform positioning with the target second terminal device, and the third information carries a positioning-related parameter; and the second terminal device performs positioning processing with the first terminal device, to obtain a relative positioning result, where the relative positioning result is used to determine the location information of the first terminal device, and the relative positioning result is a relative location relationship between the first terminal device and the target second terminal device.

The first network device may finally determine the location information of the first terminal device, and then transmit the location information of the first terminal device to the application server corresponding to the first application. Details are not described herein again.

A difference from the foregoing implementations lies in that: in this implementation, a first network device first obtains application code used for discovery from a third network device, and then carries the application code used for discovery in second information and transmits the second information to a first terminal device and a second terminal device, to trigger a discovery process between the first terminal device and the second terminal device.

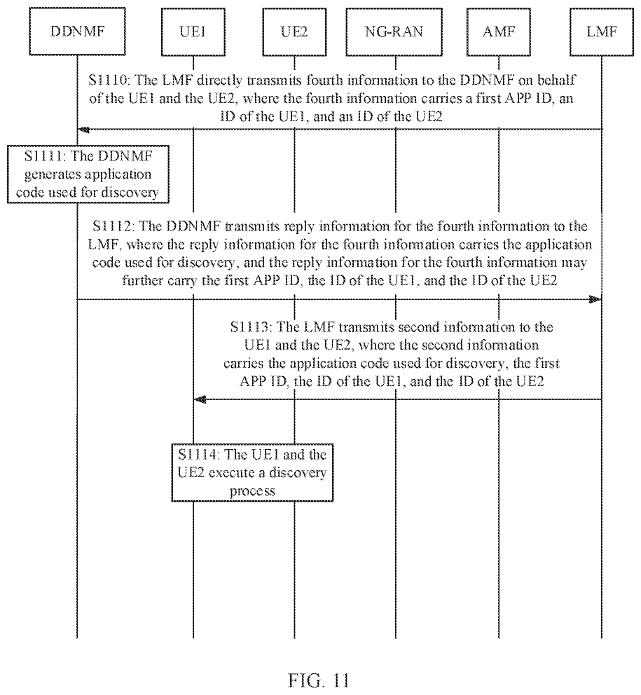

With reference to FIG. 11, the processing provided in the foregoing implementations is described by using the following example: a first terminal device is a UE1, a second terminal device (the second terminal device may be a second terminal device discovered by the first terminal device or a target second terminal device used for positioning that is determined by a first network device) is a UE2, the first network device is an LMF, a second network device is an AMF, a third network device is a DDNMF, a fourth network device is a GMLC, and an application server is an AF.

It should be noted that before S1110 is executed, the processing of S1001 to S1009 provided in FIG. 10A and FIG. 10B may be first executed. That is, after the LMF selects, according to a TAI or cell ID of an area in which the UE1 is located, one or more UE2s that have the same TAI or cell ID as the UE1, the LMF executes S1110 shown in FIG. 11. Detailed descriptions of S1001 to S1009 in FIG. 10A and FIG. 10B are the same as those in the foregoing embodiments, and therefore details are not described again. In this example, processing of S1110 to S1114 in FIG. 11 is specifically described as follows:

S1110: The LMF directly transmits fourth information to the DDNMF on behalf of the UE1 and the UE2, where the fourth information carries a first APP ID, an ID of the UE1, and an ID of the UE2.

S1111: The DDNMF generates application code used for discovery.

S1112: The DDNMF transmits reply information for the fourth information to the LMF, where the reply information for the fourth information carries the application code used for discovery, and the reply information for the fourth information may further carry the first APP ID, the ID of the UE1, and the ID of the UE2.

S1113: The LMF transmits second information to the UE1 and the UE2, where the second information carries the application code used for discovery, the first APP ID, the ID of the UE1, and the ID of the UE2. The second information further includes a ranging discovery indication, which indicates that a UE that may support ranging needs to be discovered.

S1114: The UE1 and the UE2 execute a discovery process.

After the foregoing processing is completed, all processing that is the same as S1012 to S1018 shown in FIG. 10A and FIG. 10B may be executed, and details are not described herein again. It should be noted that, the GMLC, the NEF, and the AF in FIG. 10A and FIG. 10B are not shown in FIG. 11, because the three devices are not involved in the processing of S1110 to S1114. This does not represent that the GMLC, the NEF, and the AF do not need to be used before S1110 and after S1114. The three devices are not shown in FIG. 11 merely for brevity.

In some possible implementations, the first network device transmits the second information to the third network device.

That the first network device transmits second information includes: the first network device transmits the second information to the third network device. The second information carries at least one of the following: the identity of the first terminal device; the Identity of the first application; or the identity of each second terminal device in the one or more second terminal devices. It should be understood that the second information may further carry another parameter that may be required in a discovery process. For example, the second information is further used to request to discover a second terminal device that supports positioning. This is not enumerated exhaustively in this embodiment. Detailed descriptions of the foregoing content are the same as those in the foregoing embodiments, and details are not described again.

After receiving the second information, the third network device may generate, based on the Identity of the first application, the application code used for discovery. It should be understood that the third network device may also generate the application code used for discovery with reference to at least part of the identity of the first terminal device and the identity of each second terminal device in the one or more second terminal devices, which are both within the protection scope of this embodiment. Then, the third network device carries the foregoing second information and the application code used for discovery in second information, and transmits the second information to the first terminal device and the one or more second terminal devices. Herein, the third network device may be a DDNMF entity. A manner in which the third network device generates the application code used for discovery is the same as that in the foregoing implementations, which is not limited in this embodiment.

Correspondingly, processing of the first terminal device, that is, the first terminal device receives second information, includes: the first terminal device receives the second information transmitted by the third network device, where the second information transmitted by the third network device further carries the application code used for discovery. Similarly, processing of the second terminal device may include: the second terminal device receives the second information transmitted by the third network device, where the second information transmitted by the third network device further carries the application code used for discovery.

That is, the first terminal device and the second terminal device receive the second information forwarded by the third network device. Because the third network device further generates, based on the identity of the first application, the application code used for discovery, the third network device carries the application code used for discovery when forwarding the second information. In some examples, the second information forwarded by the third network device to the first terminal device and the second terminal device may also be referred to as seventh information.

After the first terminal device and the second terminal device receive the second information transmitted by the third network device, that the first terminal device executes discovery processing to obtain a discovered second terminal device includes: the first terminal device executes the discovery processing based on the application code, to obtain the discovered second terminal device. Similarly, that the second terminal device executes a discovery process with the first terminal device includes: the second terminal device executes the discovery process with the first terminal device based on the application code. Specific processing of executing the discovery process by the first terminal device and the second terminal device is the same as that in the foregoing embodiments, and is not described again.

Further, after the first terminal device and the second terminal device complete the discovery process, the first terminal device may obtain the discovered second terminal device, and then transmit reply information for the second information. Specifically, the first terminal device transmits the reply information for the second information to the third network device.

After receiving the reply information for the second information, the third network device transmits the reply information for the second information to the first network device. Correspondingly, processing of the first network device includes: the first network device receives the reply information for the second information that is transmitted by the third network device.

Content that may be carried in the reply information for the second information is the same as that in the foregoing embodiments, and both are the identity of the second terminal device discovered by the first terminal device and the identity of the first application. Details are not described herein again.

After the first network device receives the reply information for the second information, processing of the first network device, the first terminal device, and the target second terminal device is the same as that in the foregoing implementations, that is, the first network device may finally determine location information of the first terminal device, and then transmit the location information of the first terminal device to an application server corresponding to the first application. Details are not described herein again.

A difference from the foregoing implementations lies in that: in this implementation, a first network device transmits second information to a third network device. After generating application code used for discovery, the third network device directly transmits all parameters to a first terminal device and one or more second terminal devices, to trigger a discovery process between the first terminal device and the second terminal devices. After the first terminal device feeds back reply information for the second information, the third network device feeds back the reply information for the second information to the first network device.

With reference to FIG. 12, the processing provided in the foregoing implementations is described by using the following example: a first terminal device is a UE1, a second terminal device (the second terminal device may be a second terminal device discovered by the first terminal device or a target second terminal device used for positioning that is determined by a first network device) is a UE2, the first network device is an LMF, a second network device is an AMF, a third network device is a DDNMF, a fourth network device is a GMLC, and an application server is an AF.

It should be noted that before S1210 is executed, the processing of S1001 to S1009 provided in FIG. 10A and FIG. 10B may be first executed. That is, after the LMF selects, according to a TAI or cell ID of an area in which the UE1 is located, one or more UE2s that have the same TAI or cell ID as the UE1, the LMF executes S1210 shown in FIG. 12. Detailed descriptions of S1001 to S1009 in FIG. 10A and FIG. 10B are the same as those in the foregoing embodiments, and therefore details are not described again. In this example, processing of S1210 to S1114 in FIG. 12 is specifically described as follows:

S1210: The LMF directly transmits second information to the DDNMF on behalf of the UE1 and the UE2, where the second information carries a first APP ID, an ID of the UE1, and an ID of the UE2. The second information is further used to request discovery of a UE2 that supports positioning.

S1211: The DDNMF generates application code used for discovery.

S1212: The DDNMF transmits second information to the UE1 and the UE2, where second information carries the first APP ID, the ID of the UE1, the ID of the UE2, and the application code used for discovery. The second information is further used to request discovery of a UE2 that supports positioning.

S1213: The UE1 and the UE2 execute a discovery process.

S1214: The UE1 transmits reply information for the second information to the DDNMF, where the reply information for the second information carries the first APP ID and an ID of a successfully discovered UE2.

S1215: The DDNMF transmits the reply information for the second information to the LMF.

After S1215 is completed, all processing of S1013 to S1018 shown in FIG. 10A and FIG. 10B may be executed. Details are not described herein again. It should be noted that, the GMLC, the NEF, and the AF in FIG. 10A and FIG. 10B are not shown in FIG. 12, because the three devices are not involved in the processing of S1210 to S1215. This does not represent that the GMLC, the NEF, and the AF do not need to be used before S1210 and after S1215. The three devices are not shown in FIG. 12 merely for brevity.

When the LMF cannot accurately locate the UE1, the LMF needs to trigger a discovery procedure between the UE1 and the UE2. Therefore, the UE1 and the UE2 may discover each other and establish a direct communications link, so that a positioning operation may be performed between the UE1 and the UE2. However, in a related technology, a manner in which an LMF triggers two UEs to execute discovery is unavailable, and in particular, a manner in which an LMF triggers, based on a request of an application, two UEs to execute discovery is unavailable. Therefore, how to implement that an LMF triggers a discovery procedure between two UEs to perform a subsequent positioning operation becomes a problem that needs to be resolved.

It may be learned that, by using the solutions provided in this embodiment, in response to a request of a first application to obtain a location of a first terminal device, a network device may trigger the first terminal device to execute a discovery process, to determine a target second terminal device used for positioning. In this way, the following manner is implemented: in response to a request of an application to locate a terminal device, a network device triggers the terminal device to execute discovery. A manner of triggering two terminal devices to execute discovery processing is added, and therefore discovery processing between terminal devices can be applied to more scenarios. In addition, the following problem in a related technology is further resolved: a network device cannot trigger, based on a request of an application, a terminal device to execute discovery processing.

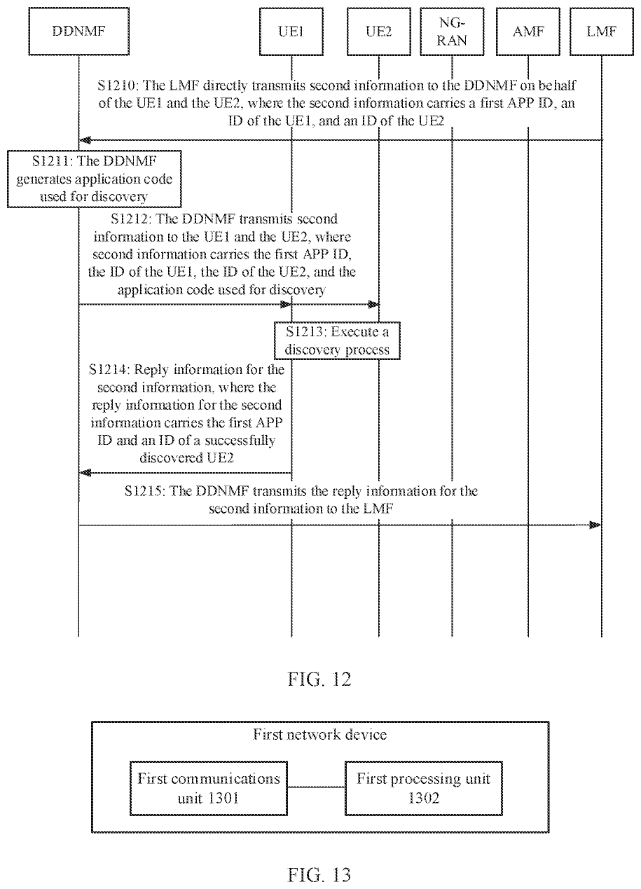

FIG. 13 is a schematic block diagram of a first network device according to an embodiment of this application. The first network device may include:
a first communications unit 1301, configured to: receive first information, where the first information is used to request positioning, and the first information is related to a first application that requests a location of a first terminal device; and transmit second information, where the second information is used to trigger the first terminal device to execute a discovery process, to determine a target second terminal device used for positioning.

The first information carries an identity of the first terminal device and an identity of the first application.

In a case in which the first application is an external application, the identity of the first application is obtained through mapping based on an original identity of the first application.

The first network device further includes:
a first processing unit 1302, configured to determine one or more second terminal devices based on related information of an area in which the first terminal device is located, where the one or more second terminal devices are located in the same area as the first terminal device.

The first communications unit 1301 is configured to obtain the related information of the area in which the first terminal device is located from a second network device.

The related information of the area in which the first terminal device is located includes at least one of the following: a tracking area identity TAI of the area in which the first terminal device is located, or a cell ID of the area in which the first terminal device is located.

The second information carries at least one of the following: the identity of the first terminal device; the identity of the first application; or an identity of each second terminal device in the one or more second terminal devices.

The second information is further used to request discovery of a second terminal device that supports positioning.

The first communications unit is configured to: receive reply information for the second information, where the reply information for the second information is used to indicate a second terminal device discovered by the first terminal device; transmit third information, where the third information is used to instruct the first terminal device to perform positioning with the target second terminal device, and the third information carries a positioning-related parameter; and receive a relative positioning result.

The first processing unit is configured to: determine the target second terminal device used for positioning from the second terminal device discovered by the first terminal device; and determine location information of the first terminal device based on the relative positioning result, where the relative positioning result is a relative location relationship between the first terminal device and the target second terminal device.

The reply information for the second information carries an identity of the second terminal device discovered by the first terminal device and the identity of the first application.

The first communications unit is configured to separately transmit the second information to the first terminal device and each second terminal device in the one or more second terminal devices.

The first communications unit is configured to receive the reply information for the second information that is transmitted by the first terminal device.

The first communications unit is configured to: transmit fourth information to a third network device, where the fourth information is used to request the third network device to generate application code used for discovery; and receive reply information for the fourth information that is transmitted by the third network device, where the reply information for the fourth information carries the application code used for discovery.

The fourth information carries at least one of the following: the identity of the first application, the identity of the first terminal device, or the identity of each second terminal device in the one or more second terminal devices.

The second information further carries application code used for discovery.

The first communications unit is configured to transmit the second information to a third network device.

The first communications unit is configured to receive the reply information for the second information that is transmitted by the third network device.

The first network device is a location management function LMF entity.

The second network device is an access and mobility management function AMF entity.

The third network device is a direct discovery name management function DDNMF entity.

The first network device according to this embodiment of this application can implement corresponding functions of the first network device in the foregoing method embodiments. For procedures, functions, implementations, and beneficial effects corresponding to modules (submodules, units, or components) in the first network device, refer to corresponding descriptions in the foregoing method embodiments. Details are not described herein again.

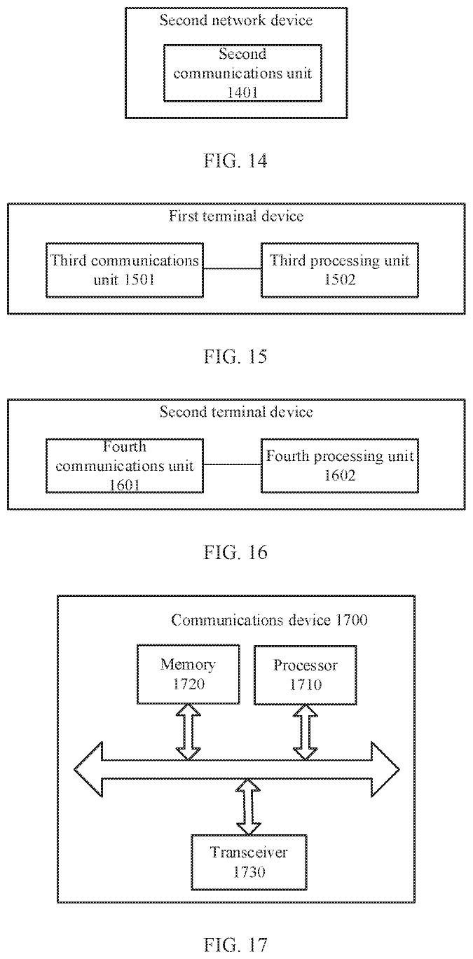

FIG. 14 is a schematic block diagram of a second network device according to an embodiment of this application. The second network device may include:
a second communications unit 1401, configured to transmit first information to a first network device, where the first information is used to request positioning, and the first information is related to a first application that requests a location of a first terminal device.

The first information carries an identity of the first terminal device and an identity of the first application.

The second communications unit is configured to receive a positioning request transmitted by a fourth network device, where the positioning request carries the identity of the first terminal device and the identity of the first application.

In a case in which the first application is an external application, the identity of the first application is obtained through mapping based on an original identity of the first application.

The second communications unit is configured to provide related information of an area in which the first terminal device is located for the first network device, where the related information of the area in which the first terminal device is located is used by the first network device to determine one or more second terminal devices located in the same area as the first terminal device.

The related information of the area in which the first terminal device is located includes at least one of the following: a tracking area identity TAI of the area in which the first terminal device is located, or a cell ID of the area in which the first terminal device is located.

The fourth network device is a gateway mobile location center GMLC.

The first network device is a location management function LMF entity, and/or, the second network device is an access and mobility management function AMF entity.

The second network device according to this embodiment of this application can implement corresponding functions of the second network device in the foregoing method embodiments. For procedures, functions, implementations, and beneficial effects corresponding to modules (submodules, units, or components) in the second network device, refer to corresponding descriptions in the foregoing method embodiments. Details are not described herein again. It should be understood that, although not shown in FIG. 14, the second network device may further include a second processing unit. The second processing unit may be configured to process and generate the related information of the area in which the first terminal device is located, and the like, and may further perform processing such as demodulation on received information or data. Details are not described again. It should be noted that functions of modules (submodules, units, components, or the like) in the second network device according to this embodiment of this application may be implemented by different modules (submodules, units, components, or the like), or may be implemented by a same module (submodule, unit, component, or the like).

FIG. 15 is a schematic block diagram of a first terminal device according to an embodiment of this application. The first terminal device may include:
a third communications unit 1501, configured to receive second information, where the second information is used to trigger the first terminal device to execute a discovery process, to determine a target second terminal device used for positioning.

The second information carries at least one of the following: an identity of the first terminal device; an ID of a first application; or an identity of each second terminal device in one or more second terminal devices.

The second information is further used to request discovery of a second terminal device that supports positioning.

The first terminal device further includes:
a third processing unit 1502, configured to control execution of a discovery process by using the third communications unit, to obtain a discovered second terminal device.

The third communications unit 1501 is configured to transmit reply information for the second information, where the reply information for the second information is used to indicate the second terminal device discovered by the first terminal device.

The reply information for the second information carries an identity of the second terminal device discovered by the first terminal device and the identity of the first application.

The third communications unit is configured to: receive third information transmitted by a first network device, where the third information is used to instruct the first terminal device to perform positioning with the target second terminal device, and the third information carries a positioning-related parameter; and transmit a relative positioning result to the first network device, where the relative positioning result is used to determine location information of the first terminal device, and the relative positioning result is a relative location relationship between the first terminal device and the target second terminal device. The third processing unit is configured to perform positioning processing with the target second terminal device by using the third communications unit, to obtain the relative positioning result.

The third communications unit is configured to receive the second information transmitted by the first network device, and transmit the reply information for the second information to the first network device.

The third communications unit is configured to: transmit fifth information to a third network device, where the fifth information is used to request the third network device to generate application code used for discovery; and receive reply information for the fifth information that is transmitted by the third network device, where the reply information for the fifth information carries the application code used for discovery. The third processing unit is configured to execute discovery processing based on the application code and by using the third communications unit, to obtain the discovered one or more second terminal devices.

The fifth information carries at least one of the following: the identity of the first application, the identity of the first terminal device, or the identity of each second terminal device in the one or more second terminal devices.

The third communications unit is configured to: receive the second information transmitted by a third network device, where the second information transmitted by the third network device further carries application code used for discovery; and transmit the reply information for the second information to the third network device.

The second information further carries application code used for discovery.

The third processing unit is configured to execute discovery processing based on the application code and by using the third communications unit, to obtain the discovered second terminal device.

The first network device is a location management function LMF entity.

The third network device is a direct discovery name management function DDNMF entity.

The first terminal device according to this embodiment of this application can implement a corresponding function of the second terminal device in the foregoing method embodiments. For procedures, functions, implementations, and beneficial effects corresponding to modules (submodules, units, or components) in the first terminal device, refer to corresponding descriptions in the foregoing method embodiments. Details are not described herein again.

FIG. 16 is a schematic block diagram of a second terminal device according to an embodiment of this application. The second terminal device may include:
a fourth communications unit 1601, configured to receive second information, where the second information is used to trigger the second terminal device to execute a discovery process with a first terminal device, to determine a target second terminal device used for positioning.

The second information carries at least one of the following: an identity of the first terminal device; an ID of a first application; or an identity of each second terminal device in one or more second terminal devices.

The second information is further used to request discovery of a second terminal device that supports positioning.

The second terminal device further includes:
a fourth processing unit 1602, configured to: in a case in which third information transmitted by a first network device is received, determine the target second terminal device that performs positioning as the first terminal device, where the third information is used to instruct the first terminal device to perform positioning with the target second terminal device, and the third information carries a positioning-related parameter; and perform positioning processing with the first terminal device, to obtain a relative positioning result, where the relative positioning result is used to determine location information of the first terminal device, and the relative positioning result is a relative location relationship between the first terminal device and the target second terminal device.

The fourth communications unit is configured to receive the second information transmitted by the first network device.

The fourth communications unit is configured to: transmit sixth information to a third network device, where the sixth information is used to request the third network device to generate application code used for discovery; and receive reply information for the sixth information that is transmitted by the third network device, where the reply information for the sixth information carries the application code used for discovery. The fourth processing unit is configured to execute a discovery process with the first terminal device based on the application code and by using the fourth communications unit.

The sixth information carries at least one of the following: the identity of the first application, the identity of the first terminal device, or the identity of each second terminal device in the one or more second terminal devices.

The fourth communications unit is configured to receive the second information transmitted by a third network device, where the second information transmitted by the third network device further carries application code used for discovery.

The second information further carries application code used for discovery.

The fourth processing unit is configured to execute a discovery process with the first terminal device based on the application code and by using the fourth communications unit.

The first network device is a location management function LMF entity.

The third network device is a direct discovery name management function DDNMF entity.

The second terminal device according to this embodiment of this application can implement a corresponding function of the second terminal device in the foregoing method embodiments. For procedures, functions, implementations, and beneficial effects corresponding to modules (submodules, units, or components) in the second terminal device, refer to corresponding descriptions in the foregoing method embodiments. Details are not described herein again.

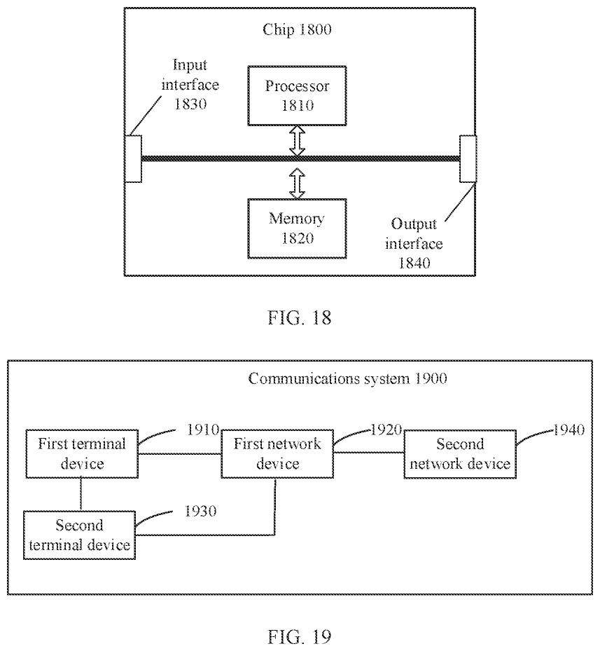

FIG. 17 is a schematic structural diagram of a communications device 1700 according to an embodiment of this application. The communications device 1700 includes a processor 1710, and the processor 1710 may invoke a computer program from a memory and run the computer program, to cause the communications device 1700 to implement a method in embodiments of this application.

In an implementation, the communications device 1700 may further include a memory 1720. The processor 1710 may invoke a computer program from the memory 1720 and run the computer program, to cause the communications device 1700 to implement a method in embodiments of this application. The memory 1720 may be a separate component independent of the processor 1710, or may be integrated into the processor 1710.

In an implementation, the communications device 1700 may further include a transceiver 1730. The processor 1710 may control the transceiver 1730 to communicate with another device. Specifically, the processor 1710 may transmit information or data to the another device, or receive information or data transmitted by the another device. The transceiver 1730 may include a transmitter and a receiver. The transceiver 1730 may further include an antenna, and a quantity of antennas may be one or more.

In an implementation, the communications device 1700 may be a first terminal device in embodiments of this application, and the communications device 1700 may implement a corresponding procedure implemented by a first terminal device in the methods according to embodiments of this application. For brevity, details are not described herein again. In an implementation, the communications device 1700 may be a first network device in embodiments of this application, and the communications device 1700 may implement a corresponding procedure implemented by a first network device in the methods according to embodiments of this application. For brevity, details are not described herein again. In an implementation, the communications device 1700 may be a second terminal device in embodiments of this application, and the communications device 1700 may implement a corresponding procedure implemented by a second terminal device in the methods according to embodiments of this application. For brevity, details are not described herein again. In an implementation, the communications device 1700 may be a second network device in embodiments of this application, and the communications device 1700 may implement a corresponding procedure implemented by a second network device in the methods according to embodiments of this application. For brevity, details are not described herein again.

FIG. 18 is a schematic structural diagram of a chip 1800 according to an embodiment of this application. The chip 1800 includes a processor 1810, and the processor 1810 may invoke a computer program from a memory and run the computer program, to implement a method in embodiments of this application.

In an implementation, the chip 1800 may further include a memory 1820. The processor 1810 may invoke a computer program from the memory 1820 and run the computer program, to implement a method executed by the terminal device or the network device in embodiments of this application. The memory 1820 may be a separate component independent of the processor 1810, or may be integrated into the processor 1810.

In an implementation, the chip 1800 may further include an input interface 1830. The processor 1810 may control the input interface 1830 to communicate with another device or chip, and specifically, may obtain information or data transmitted by the another device or chip.

In an implementation, the chip 1800 may further include an output interface 1840. The processor 1810 may control the output interface 1840 to communicate with another device or chip, and specifically, may output information or data to the another device or chip.

In an implementation, the chip may be applied to a first terminal device in embodiments of this application, and the chip may implement a corresponding procedure implemented by a first terminal device in the methods according to embodiments of this application. For brevity, details are not described herein again. In an implementation, the chip may be applied to a first network device in embodiments of this application, and the chip may implement a corresponding procedure implemented by a first network device in the methods according to embodiments of this application. For brevity, details are not described herein again. In an implementation, the chip may be applied to a second terminal device in embodiments of this application, and the chip may implement a corresponding procedure implemented by a second terminal device in the methods according to embodiments of this application. For brevity, details are not described herein again. In an implementation, the chip may be applied to a second network device in embodiments of this application, and the chip may implement a corresponding procedure implemented by a second network device in the methods according to embodiments of this application. For brevity, details are not described herein again.

Chips applied to the first terminal device, the second terminal device, the first network device, and the second network device may be a same chip or different chips. It should be understood that the chip mentioned in this embodiment of this application may alternatively be referred to as a system-level chip, a system chip, a chip system, a system-on-chip, or the like.

The processor mentioned above may be a general-purpose processor, a digital signal processor (DSP), a field programmable gate array (FPGA), an application-specific integrated circuit (ASIC) or another programmable logic device, a transistor logic device, a discrete hardware component, or the like. The general-purpose processor mentioned above may be a microprocessor, or may be any conventional processor.

The memory mentioned above may be a volatile memory or a non-volatile memory, or may include both a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM). It should be understood that, by way of example but not limitative description, for example, the memory in this embodiment of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (DR RAM), or the like. In other words, the memory in this embodiment of this application includes but is not limited to these memories and any memory of another proper type.

FIG. 19 is a schematic block diagram of a communications system 1900 according to an embodiment of this application. The communications system 1900 includes a first terminal device 1910, a first network device 1920, a second terminal device 1930, and a second network device 1940. The first terminal device 1910 is configured to execute the foregoing information processing methods; the first network device 1920 is configured to execute the foregoing information processing methods; the second terminal device 1930 is configured to execute the foregoing information processing methods; and the second network device 1940 is configured to execute the foregoing information processing methods. Functions implemented by the first terminal device 1910, the first network device 1920, the second terminal device 1930, and the second network device 1940 have already been described in detail in the foregoing embodiments. For brevity, details are not described herein again.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any available medium accessible by a computer or a data storage device such as a server or a data center that integrates one or more available media. The available medium may be a magnetic medium (for example, a floppy disk, a hard disk, or a magnetic tape), an optical medium (for example, a DVD), a semiconductor medium (for example, a solid state disk (SSD)), or the like.

It should be understood that, in embodiments of this application, sequence numbers of the foregoing processes do not mean execution sequences. The execution sequences of the processes should be determined based on functions and internal logic of the processes, and should not be construed as any limitation on the implementation processes of embodiments of this application. It may be clearly understood by a person skilled in the art that, for the purpose of convenient and brief description, for a detailed working process of the foregoing system, apparatus, and unit, refer to corresponding processes in the foregoing method embodiments, and details are not described herein again.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An information processing method, comprising:
receiving, by a first network device, first information, wherein the first information is used to request positioning; and
transmitting, by the first network device, second information, wherein the second information is used to trigger the first terminal device to execute a discovery process, to determine a target second terminal device used for positioning.

2. The method according to claim 1, wherein the first information carries an identity of the first terminal device and an identity of the first application.

3. The method according to claim 2, wherein the method further comprises:
determining, by the first network device, one or more second terminal devices based on the related information of the area in which the first terminal device is located.

4. The method according to claim 3, wherein the second information carries at least one of following: the identity of the first terminal device; the Identity of the first application; or an identity of each second terminal device in the one or more second terminal devices.

5. The method according to claim 4, wherein the second information is further used to request discovery of a second terminal device that supports positioning.

6. The method according to claim 1, wherein after the transmitting, by the first network device, second information, the method further comprises:
receiving, by the first network device, reply information for the second information, wherein the reply information for the second information is used to indicate one or more second terminal device discovered by the first terminal device;
determining, by the first network device, the target second terminal device used for positioning from the second terminal device discovered by the first terminal device;
transmitting, by the first network device, third information, wherein the third information is used to instruct the first terminal device to perform positioning with the target second terminal device, and the third information carries a positioning-related parameter; and
receiving, by the first network device, a relative positioning result, and determining location information of the first terminal device based on the relative positioning result, wherein the relative positioning result is a relative location relationship between the first terminal device and the target second terminal device.

7. The method according to claim 6, wherein the reply information for the second information carries an identity of the second terminal device discovered by the first terminal device and the identity of the first application.

8. The method according to claim 7, wherein the transmitting, by the first network device, second information comprises:
separately transmitting, by the first network device, the second information to the first terminal device and each second terminal device in the one or more second terminal devices.

9. A first network device, comprising:
a first communications unit, configured to: receive first information, wherein the first information is used to request positioning; and transmit second information, wherein the second information is used to trigger the first terminal device to execute a discovery process, to determine a target second terminal device used for positioning.

10. The first network device according to claim 9, wherein the first information carries an identity of the first terminal device and an identity of the first application.

11. The first network device according to claim 10, wherein the first network device further comprises:
a first processing unit, configured to determine one or more second terminal devices based on related information of an area in which the first terminal device is located; and
the first communications unit is configured to obtain the related information of the area in which the first terminal device is located from a second network device.

12. The first network device according to claim 11, wherein the second information carries at least one of following: the identity of the first terminal device; the identity of the first application; or an identity of each second terminal device in the one or more second terminal devices.

13. The first network device according to claim 12, wherein the second information is further used to request discovery of a second terminal device that supports positioning.

14. The first network device according to claim 9, wherein
the first communications unit is configured to: receive reply information for the second information, wherein the reply information for the second information is used to indicate one or more second terminal device discovered by the first terminal device; transmit third information, wherein the third information is used to instruct the first terminal device to perform positioning with the target second terminal device, and the third information carries a positioning-related parameter; and receive a relative positioning result; and
the first processing unit is configured to: determine the target second terminal device used for positioning from the second terminal device discovered by the first terminal device; and determine location information of the first terminal device based on the relative positioning result, wherein the relative positioning result is a relative location relationship between the first terminal device and the target second terminal device.

15. A first terminal device, comprising:
a third communications unit, configured to receive second information, wherein the second information is used to trigger the first terminal device to execute a discovery process, to determine a target second terminal device used for positioning.

16. The first terminal device according to claim 15, wherein the second information carries at least one of following: an identity of the first terminal device; an ID of a first application; or an identity of each second terminal device in one or more second terminal devices.

17. The first terminal device according to claim 16, wherein the second information is further used to request discovery of a second terminal device that supports positioning.

18. The first terminal device according to claim 17, wherein the first terminal device further comprises:
a third processing unit, configured to control execution of a discovery process by using the third communications unit, to obtain a discovered second terminal device; and
the third communications unit is configured to transmit reply information for the second information, wherein the reply information for the second information is used to indicate the second terminal device discovered by the first terminal device.

19. The first terminal device according to claim 18, wherein the reply information for the second information carries an identity of the second terminal device discovered by the first terminal device and the identity of the first application.

20. The first terminal device according to claim 19, wherein
the third communications unit is configured to: receive third information transmitted by a first network device, wherein the third information is used to instruct the first terminal device to perform positioning with the target second terminal device, and the third information carries a positioning-related parameter; and transmit a relative positioning result to the first network device, wherein the relative positioning result is used to determine location information of the first terminal device, and the relative positioning result is a relative location relationship between the first terminal device and the target second terminal device; and
the third processing unit is configured to perform positioning processing with the target second terminal device by using the third communications unit, to obtain the relative positioning result.
